(19) United States
(12) Patent Application Publication
(10) Pub. No.: US 2009/0150316 A1
(43) Pub. Date: Jun. 11, 2009

(54) Methods and Systems for Evaluating Behavior in Relation to Ethical Values

(75) Inventors: Nicolai Peitersen, London (GB); Jens Martin Skibsted, Copenhagen (DK)

Correspondence Address: FOX ROTHSCHILD LLP, P O BOX 592, 112 NASSAU STREET, PRINCETON, NJ, 08542-0592, US

(73) Assignee: ACTICS LTD., London (GB)

(21) Appl. No.: 12/189,058

(22) Filed: Aug. 8, 2008

Related U.S. Application Data
(60) Provisional application No. 60/954,584, filed on Aug. 8, 2007.

(51) Int. Cl. G06N 5/02

(52) U.S. Cl. 706/46

(57) ABSTRACT

Methods and system for evaluating the behavior of users in relation to one or more ethical values are provided. The methods can comprise obtaining inputs from stakeholders or proxies rating the performance of the user in relation to the one or more ethical values. The inputs can be processed so that inputs of greater importance to the user are given a higher weight than inputs of lesser importance. An overall rating of the performance of the user in relation to the ethical values can then be determined based on the weighted inputs. The methods can be performed using systems comprising a computing device that accepts the ratings, and is programmed with an algorithm that weights the ratings and calculates the overall rating based on the weighted ratings.

### CROSS-REFERENCE TO RELATED APPLICATIONS

This application claims the benefit under 35 U.S.C. 119(e) to U.S. provisional application No. 60/954,584, filed august 8, 2007, the contents of which is incorporated by reference herein in its entirety.

### TECHNICAL FIELD

The present application relates to methods and systems that facilitate the collection and processing of information to evaluate the behavior of an individual, organization, or company in relation to various ethical values.

### BACKGROUND

In a recent survey of 8,000 international companies, eighty percent of the participants expressed a belief that corporate ethical values have a major impact on the primary stakeholders, i.e., the employees and customers, of the company. However, few if any companies presently know how to manage their ethical values, or how to integrate ethical values into their day to day operations. Moreover, all stakeholders, e.g., employees, customers, bloggers, investors, etc., generally desire greater voice in how companies run their business. Also, many companies wish to be perceived an attractive employer in order to attract high-quality employees.

### SUMMARY OF THE INVENTION

Methods and system for evaluating the behavior of users in relation to one or more ethical values are provided. The methods can comprise obtaining inputs from stakeholders or proxies rating the performance of the user in relation to the one or more ethical values. The inputs can be processed so that inputs of greater importance to the user are given a higher weight than inputs of lesser importance. An overall rating of the performance of the user in relation to the ethical values can then be determined based on the weighted inputs. The methods can be performed using systems comprising a computing device that accepts the ratings, and is programmed with an algorithm that weights the ratings and calculates the overall rating based on the weighted ratings.

### BRIEF DESCRIPTION OF THE DRAWINGS

The foregoing summary, as well as the following detailed description of preferred embodiments, are better understood when read in conjunction with the appended drawings. The drawings are presented for illustrative purposes only, and the scope of the appended claims is not limited to the specific embodiments shown in the drawings. In the drawings:

FIG. 1 is a flow diagram depicting an exemplary method for evaluating the behavior of users in relation to one or more ethical values;

FIG. 2 depicts an algorithm for processing (weighting) inputs obtained from proxies (stakeholders) as part of the method depicted in FIG. 1;

FIG. 3 is a diagrammatic representation of an exemplary system for performing the method depicted in claim 1; and

FIG. 4 is a flow diagram depicting activities of a proxy in practicing the method depicted in claim 1.

### DETAILED DESCRIPTION

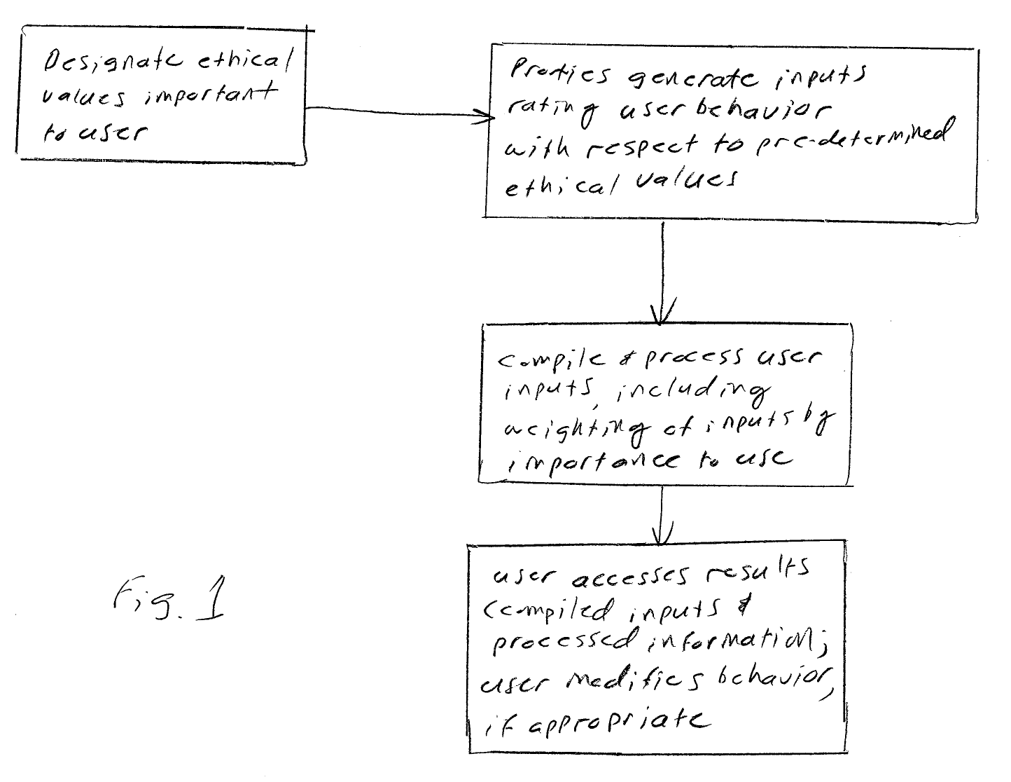

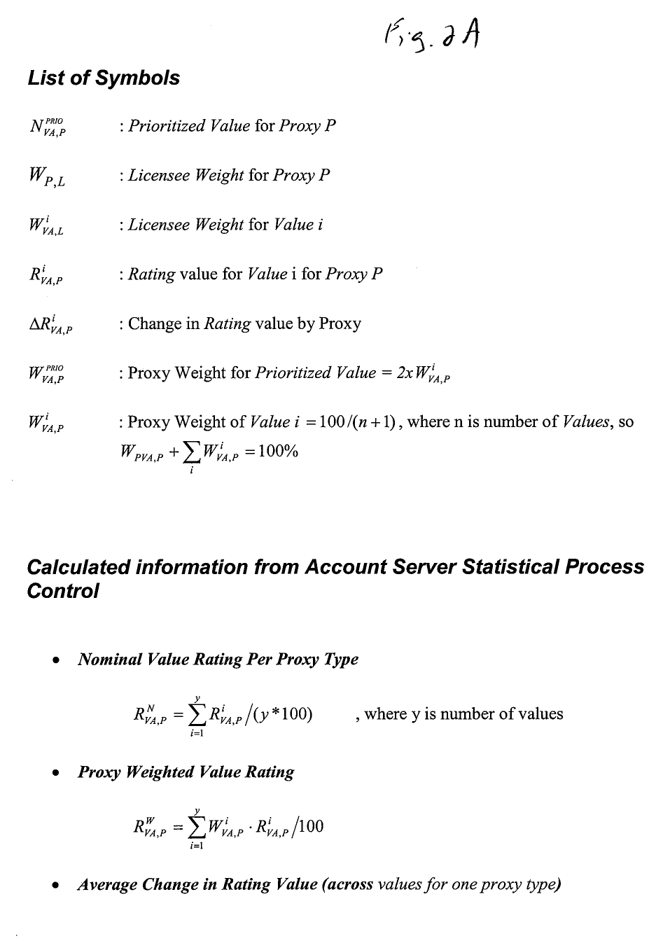

FIG. 1 is a flow chart depicting an exemplary method 10 for evaluating the ethical behavior of a user, based on inputs from proxies or proxies. The user can be, for example, an individual, an organization, a company, a partnership, etc.

The method 10 includes obtaining inputs from stakeholders or proxies. The inputs take the form of a rating of the user's behavior in relation to various pre-selected ethical values. The proxies can be individuals who are in a position to evaluate the behavior of the user in relation to the pre-selected ethical values. In applications where the user is a company, the proxies can be, for example, employees and customers of the company. In applications where the user is an individual, the proxies can be, for example, friends, colleagues, family members, or other acquaintances of the user.

The ethical values can be tailored to a particular user, and can be selected by the user, the proxies, or others. An ethical value can be defined, for example, as the general quality of an action that was prompted by the feeling of proximity (closeness) towards something or someone. Examples of ethical values that can be rated the proxies can include: solidarity; truthfulness; devotion; benevolence; care; confidentiality; environmentalism; honesty; openness; reliability; etc. Definitions of the various ethical values can be presented to the proxies to assist the proxies in their evaluations.

Any suitable rating scale can be used for the proxy inputs. For example, a rating scale of zero to one-hundred percent can be used, where a rating of fifty percent represents a neutral rating, a rating of one-hundred percent represents full compliance with the associated value, and zero represents no compliance whatsoever with the value.

The ratings can be acquired via an electronic medium or other suitable means. For example, each proxy can provide inputs to a central computing device. Inputs can be generated on another computing device that is accessible to the proxy and is communicatively coupled to the central computing device by way of a suitable communications network.

The central computing device can act as a central data base for the individual ratings from the proxies. In addition, the central computing device can be programmed to process the ratings. For example, the central computing device can be programmed with an algorithm that provides a value, referred to hereinafter as an ethical index number, that provides an weighted or un-weighted average of the individual proxy ratings.

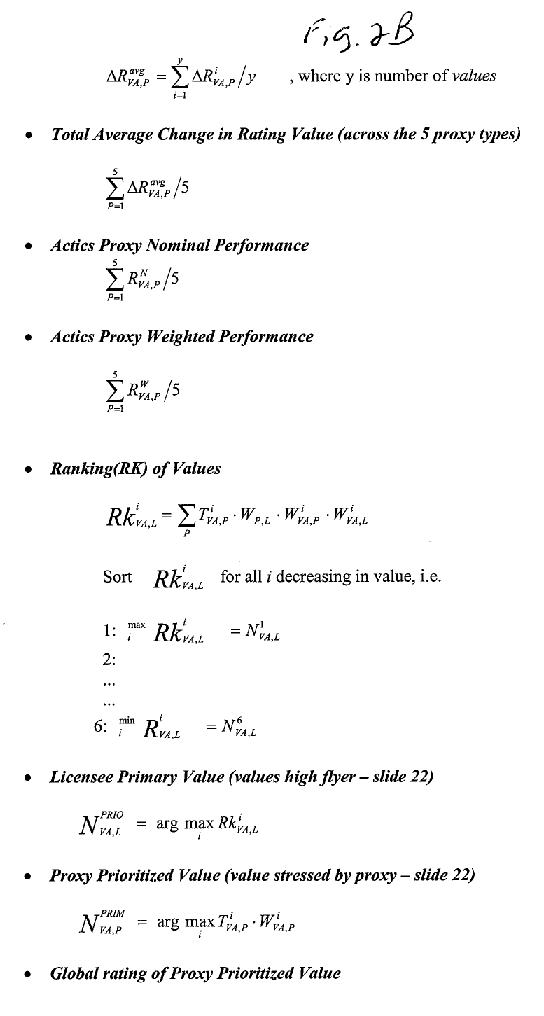

For example, the algorithm can weight the various ratings by category, to enhance the potential significance of the ethical index number to a particular user. In one possible embodiment, the ratings can be weighted to that ratings from a company's employees are giver greater (or less) weight than ratings from the company's customers. The ratings can also be weighted so that ratings associated with specific ethical values are greater or less weight than the ratings associated with other ethical values. The ethical index number can thus be tailored to maximize the significance and usefulness thereof to a particular user. An example of an algorithm suitable for producing an ethical index number in this manner is set forth in FIGS. 2A-2C.

The ethical index number thus provides the user with feedback concerning the user's ethical behavior, as perceived by the proxies associated with the user. The user can utilize the ethical index number to affirm, or alter the user's behavior. In particular, the user can be provided with a real time indicator and early warning on how well the user it performing from an ethical standpoint, e.g., from the standpoint of the relational feelings all stakeholders have to toward the user. Moreover, the user's performance can be broken down by each of the rated ethical values and stakeholders (proxies), etc. This quantification of the ethical behavior of the user can also make it possible to analyze statistical interdependencies (correlation analysis) between factors such as the stakeholders, the user's ethical profile, and economic performance. In this way, valuable information can be provided regarding, for example, similarities in the understanding of the organization across different segments and stakeholders, the link between sales and ethical performance over a given period, etc.

In one possible embodiment, the ethical index number can be calculated based exclusively on ratings received from proxies over the prior thirty days or some other suitable time period. This feature permits the user to track the progress or degradation in the ethical performance of the user as perceived by the proxies.

The central computing device can also be programmed with an algorithm that causes the central computing device to search the internet for information concerning the user, and to recognize and retrieve information pertinent to the ethical behavior of the user. Such information can potentially be obtained, for example, from online news sources, magazine and periodicals, web logs (blogs), etc., using internet search engines and computer-based tools that facilitate semantic analyses of text. This feature can potentially yield useful information concerning the ethical attitudes and trends of the general public and specific interest groups the toward the user, particularly where the user is well known to the public. If desired, the information can be factored into the ethical index number.

The ethical index number and the ratings of the proxies can provide an indication of the overall value and attractiveness of a company. The ethical index number and/or the ratings of the proxies can thus be provided to individuals or organizations having an actual or potential interest in the company. For example, the ethical index number and/or the ratings of the proxies can be provided to:
a) Investors as a portfolio monitor on how well their portfolio companies are performing ethically (manage their social capital)
b) Consumers as a personal downloadable plug-in for computers and mobile phones to get ready-at-hand ethical performance of brands before they make buying decisions
c) Supply Chain Managers to monitor and provide a 24/7 ethical tracking of suppliers in relation to the various standards they are required to meet
d) Human Resource department directors to keep track on how well the employees live the corporate values, where to improve, and how to improve.
e) Marketing Directors to improve the affinity and affiliation of clients to the company
f) The general public, to nominate agents, e.g., companies, organizations and politicians, for ethical assessment.

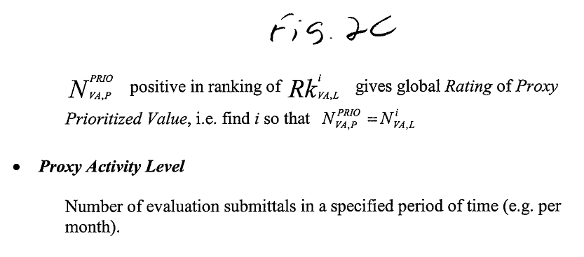

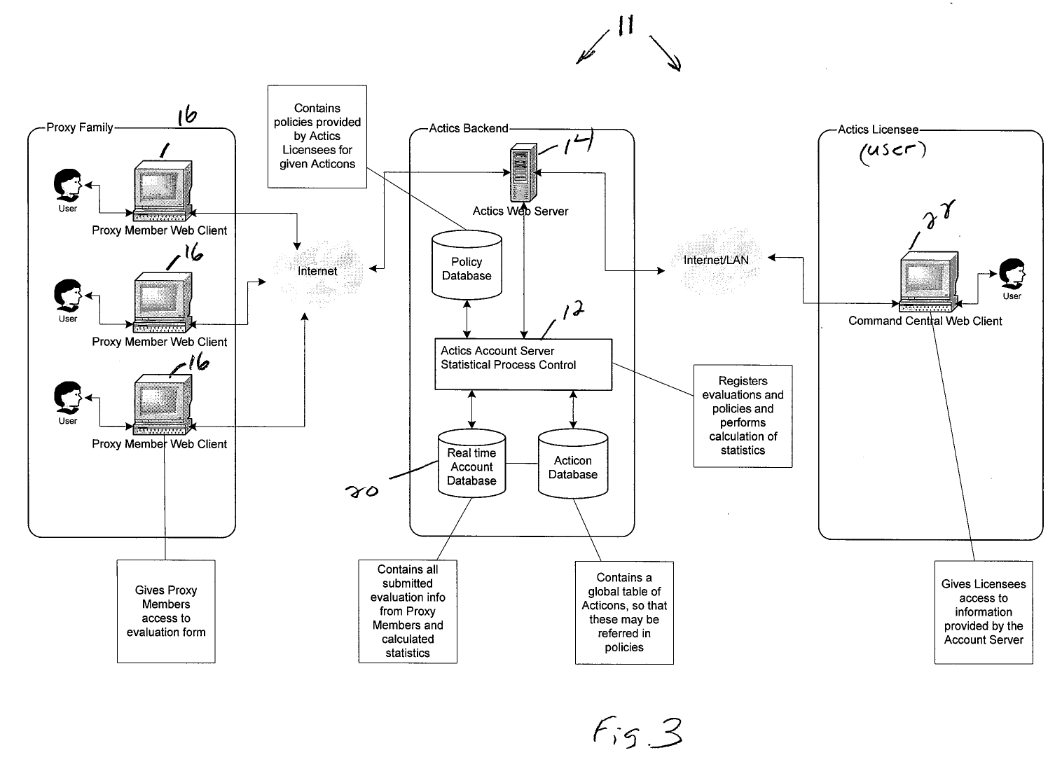

FIG. 3 depicts a system 11 for practicing the above-described methods, and variations thereof. The system 11 comprises a computing device, such as a server 12. The server 12 is programmed with software, i.e., computer-executable instructions, that permits the server 12 to function as the central computing device described above in relation to the exemplary methods. The server 12 can include a computer-readable medium on which the computer-executable instructions are stored; and a processor of any suitable type for executing the computer-executable instructions.

A first, or real-time account data base 20 can be stored on a memory-storage device of the server 12. The first data base 20 can contain the rating information submitted by the proxies, and the ethical index numbers and other statistics generated from the rating information.

Communication between the proxies and the server 12 can be facilitated by way of the internet using a suitable computing device such as a web server 14, and other computing devices such as desktop computers 16 (which act as web clients) accessible to the proxies. Communication between the proxies and the server 12 can be facilitated by other suitable communication networks, such as a local area network, in alternative embodiments.

The proxy can interface with the web server 14 using a standard web browser, such as Microsoft Internet Explorer, installed on the desktop computer 16. The web server 14 can provide a series of prompts and displays to the proxy, to guide the proxy through the ethical evaluation process for the user. For example, the following series of prompts and displays can be communicated to the proxy by way of the internet and the desktop computer 16:
A button for submittal of a new evaluation
Ethical values to be rated, in an order following the relative importance for user, W_{VA,L}ⁱ. The ethical value with the highest importance is displayed as number one.
Input of your rating R_{VA}ⁱ (for each ethical value).
Display of the rating for each ethical value. The rating can take a value within in the range of zero to one-hundred percent for each ethical value.
Display of average public rating, R_{VA,P}^{avg}
Input and display what should I prioritize?, which automatically assign a weight to the rating for the prioritized value double the weight of the remaining values, so total weight will be one-hundred percent. For example, for six total values, the prioritized value will get a weight of 28.57 percent (W_{VA,P}ⁱ), while the remaining five values get an equal weight of 14.29 percent (W_{VA,P}ⁱ)
Wishes: Wishes for improvement of User performance can be entered. These are cleared after submittal.
Display the overall and weighted nominal ratings, on a month-to-month basis.
Display the percentage change, on a month-to-month basis, of the overall and weighted nominal ratings.
Display number of proxies providing feedback (input).
Display global rating of the primary value of the proxy.

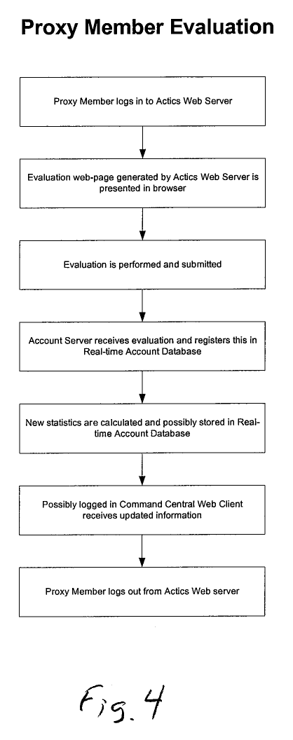

FIG. 4 is a flow chart depicting the process by which a proxy can provide inputs rating the ethical performance of a user, using the system 11.

The user (or licensee) can access the results of the rating process using a suitable computing device, such as a desktop computer 22, communicatively coupled to the web server 14 by way of the internet, a local area network, or other suitable communications network. The user can interface with the web server 14 using a standard web browser, such as Microsoft Internet Explorer, installed on the desktop computer 22. The web server 14 can provide a series of prompts and displays to the user, to help the user access the results of the rating process. For example, the following series of prompts and displays can be communicated to the user by way of the internet and the desktop computer 22:
User must login to Account Web Server.
Performance and Statistics presented in a visual and intuitive fashion:
   Performance, overall, per value and per proxy
   Rating, overall, between zero and one-hundred percent
   Proxy Performance, overall, per value and per proxy
   Overall Proxy Rating
   Values High Flyer
   Your top three concerns
   Your proxy engagement (number of accepted calls for feedback, proxies high flyer, proxy concern, value stressed by proxies)
Order of displayed Your Values follow relative importance for licensee (user), W_{VA,L}ⁱ. The ethical value with the highest weight is displayed first and so on. Weights are shown in brackets after each ethical value.
Order of displayed Your Actions is of no importance.
Order of displayed Your Proxy Family follow relative importance for licensee, W_{P,L}ⁱ. The proxy with the highest weight is displayed first and so on. Weights and number of Proxy Members are shown in brackets after each proxy type.
Wishes: Wishes for improvement of Licensee performance can be entered. These are cleared after submittal.
Display of Average Change in Token Value.
Value stressed by proxy family (inputted by each member on slide 4 under what should I prioritize?): user defined ethical value that users assess to be the number one priority. Display proxy weight and Global rating of Proxy Primary Value in brackets after the stressed ethical value.
With changes in ΔT_{AC}ⁱ sort T_{AC}ⁱ dynamically so Total Nominal Assessment changes dynamically.

The foregoing description is provided for the purpose of explanation and is not to be construed as limiting the invention. Although the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, can make numerous modifications to the invention as described herein, and changes may be made without departing from the scope and spirit of the invention as defined by the appended claims.

An example of a web-based application of the above-described method follows.

### 1.1 Data Dictionary

This data dictionary will help explain specific terms and what their meaning is. This data dictionary is extended in that it has an internal and external term. The External term is what is used on the website and visible to the end user; internal is what it is called in the code or what term the developers of the system sometime use internally. The reason for this is that some terms have changed quite a lot externally but internally have maintained the old name, rather than having to re-factor a lot of code, which would be time consuming even with available Visual Studio refactoring tools, plus the time spent would not add value to the end user. So time spent would only benefit the developers and future developers, but it of course has to be looked into before possibly getting more developers involved.

| External Term | Internal Term | Explanation |
|---|---|---|
| User (Profile) | Agent | A user of the system |
| | | wanting to receive |
| | | feedback, has values and |
| | | actions |
| Proxy (Profile) | UserProfile | A user of the system, with |
| | | no values and actions, |
| | | wanting to give feedback. It |
| | | derives from the word |
| | | proximity, meaning |
| | | nearness in space or |
| | | relation |
| Suggested Action | (Agent)Wish | An action a user type has |
| | | given to an agent |
| Proxy Network | Network/Friends/ | An agent or proxies group |
| | Proxy Family | of friends |
| Action | | We all have limited |
| | | resources, but unlimited |
| | | intentions to do what's |
| | | right. Actions are the things |
| | | you do to maximize your |
| | | ethical impact, given the |
| | | resources that you have. |
| | | Ethical actions add value to |
| | | the lives of individuals and |
| | | to the world as a whole. |
| | User type | Either a Proxy Profile or a |
| | | User |
| Nominated | Agent (IsNominated = | A User that is created by a |
| User (Profile) | true) | user type, which he then has |
| | | control over. Is used to |
| | | empower users to get the |
| | | companies they want to rate |
| | | online. |
| Value | Value | An ‘ethical value’ is the |
| | | general quality of an action |
| | | that was prompted by the |
| | | feeling of proximity |
| | | towards someone or |
| | | something. |
| Actics score | | Your Actics score includes |
| | | your rating (based on the |
| | | weighted average feedback |
| | | from your proxies), the |
| | | change in your rating in the |
| | | last 30 days, and the total |
| | | number of feedbacks that |
| | | you've received. |
| | UserType | A user of one of the types |
| | | of users we have in the |
| | | system. Right now that |
| | | would mean an Agent or a |
| | | UserProfile |
| | Entity | A representation of basic |
| | | datatypes in the system, |
| | | which can be accessed |
| | | directly by an URL in the |
| | | system. Users, Actions and |
| | | Values, plus the internal |
| | | ones used by the system |
| | | (eg./login). Generally it s |
| | | only the root URL that is |
| | | stored as an entity in the |
| | | database |
| | Core | The central part of the |
| | | Actics code, where the |
| | | Busniness Logic happens |
| | Utilities | Part of the Actics system, |
| | | that is more general, |
| | | contains the Database |
| | | Query System and other |
| | | non-Actics-specific parts. |
| (Actics) Plugin | Plugin | A small badge that can be |
| | | placed on any website that |
| | | shows an Agents current |
| | | Actics Score and |

### 2 Architecture

This is a specification of the Actics web application that is running on www.actics.com. But it can also be applied to other systems built using the Core and Utilities libraries. This has been done to enable the creation of several private solutions of the Actics system, plus the Database-Query System could be used in a totally different system that needed to interact with a database.

### 2.1 Overview of the Architecture

An overview of the physical architecture of the Actics system is shown in FIG. 1.

### 2.2 Description of the Architecture

The Actics software is built with a three-tier design strategy to achieve a powerful, flexible and scalable architecture. Each tier is developed and handled individually. The three tiers are:
Database tier
Logic tier (Data Access Layer in FIG. 1)
Presentation tier (Web Front End in FIG. 1)

To supplement the development and ease deployment of the database, several tools have been developed. These include a tool to validate the database against the data tables in the logic tier and perform basic data definition functions on the database (drop, create tables). Also it provides access to the methods of the logic tier so one can create methods in the logical tier to create default data or otherwise manipulate the data in the database.

### 2.2.1 Database Tier

The database is a standard SQL database currently running on a Microsoft SQL Server. The .NET framework provides a driver for the Logic Tier to communicate with the database. All database queries use standard SQL and not Microsoft's own TSQL in order to have the possibility of switching to different database servers.

### 2.2.2 Logic Tier

The logic tier handles all communication between the presentation tier and the data. All input, no matter from which kind of Actics software, is thus handled the same way in relation to the database. Likewise, all data can be fed to whatever extension or version of the Actics software that may be needed. The logic tier is developed as a class library with focus on modular programming. It is important that the logic tier can work without the presentation tier and that the presentation tier never has access to the data tier. Apart from robustness, this three-Tier design provides for different presentation tiers to communicate with the same logic tiers. This means that several solutions (websites) can use the same logic tier to communicate with the database. To further decouple the Logic tier from the database, an object oriented data query language has been implemented. This enables the developer to write query to the database, without using SQL queries, which can be error prone, since they cannot be checked at compile time. Though the current OO-data query language cannot check everything at compile time, it does check a lot of the common errors gotten when writing SQL queries as strings. This OO-data query language will be further described in Section 3.1.2.

### 2.2.3 The Presentation Tier

For actics.com, the presentation layer is a web application using ASP.Net technology (active server pages using Microsoft.Net). The presentation tier is easy to maintain and the web controls are able to work without the logic tier, thereby one can change the web application to e.g. a windows form application. The visual appearance is kept in the ASP files itself and the logic is put in the code behind file that communicates with the Logic Tier. We have generally made ASP.NET controls where we have common components of the website that can be reused on several pages, thereby having functionality that can be used in several places and any changes made to it propagate to all places the control is used. The generated html from the ASP.Net pages is tested in different Web Browsers¹, is fully XHTML compliant and is optimized to keep traffic on the server at a minimum. jQuery² is used to provide cross browser compliant Javascript to the pages. ¹Internet Explorer 6 & 7, Firefox 2.X, Safari for Windows, Opera 9.5²http://jquery.com/

### 2.3 Partial Domain Models

For this document to be as useful as possible and increase in usage as a reference, it's been decided to split the Domain Models into logical subparts. This way if one is dealing with the Values subpart one can look at the Values Part alone.

### 2.3.1 User Part

### FIG. 2 User Part

User is the central domain object which contains the login information for a user of the Actics web application and a reference to either an Agent or a UserProfile depending on what type of user it is. It has a reference to an Agent if the user has a profile, with values, actions and wants to receive feedback from another user on their ethics. If the user just wants to be able to give feedback and not receive any feedback themselves. An Agent or a UserProfile then has a UserFeedback, if they have given some sort of feedback (ie. Rated, commented, etc.) or some other form of connection (ie. Proxy NetWork). UserFeedback is a common representative for both Agents and UserProfiles, which is used when ever two userTypes interact. This is done since both Agents and UserProfiles can give feedback, and we didn't want just one reference to whoever gave feedback. This also helps if we later want to add more usertypes. Each User also has a UserConfig domain object, which is used to contain all sorts of configuration data on the users, which is kept separate to minimize the size of the User domain object and keep it from getting changed every time new configuration data is added. Finally there is the UserConfirmEmail, which is a temporary Domain Object used to store information for the email confirmation mail sent to a user before the user is activated.

### 2.3.2 Agent Part

The Agent Part is the central part of the Actics system and the most extensive. The central domain object is the Agent. Like the other central parts, an Agent has an Entity. Each Agent can also choose to register which country they are from, which is shown by the reference to the Countries domain object. Each Agent also has some statistics saved in AgentStats, which has been separated from Agent to keep the size of the Agent domain object down and enable further expansions of AgentStats in the future. Each Agent can also choose to have a plugin created which is saved in Plugin.

Each Agent can choose many Values, this is done via AgentValues, where a reference to a Value and a ValueDefinintion is saved. For each AgentValue an Agent can choose Actions, which are bound via AgentActions and is linked to the binding between the Agent and AgentValues. All userTypes can then rate an Agent on his Values and Actions, which is stored in the AgentRatings, which is also bound to the connection between the Agent and his chosen Values in AgentValue.

Furthermore each Agent can receive comments and suggested actions, which is shown by the connection to AgentComment and AgentWish.

2.3.3 UserFeedback Part

As written in 2.3.1 UserFeedback is binding object between all the domain objects that all usertypes can use. It is an intermediary that can represent any of the userTypes that are in the system and any that might be added later on). Any usertype can send messages to another and therefore the UserFeedback has a reference to a sender UserFeedback and a receiver UserFeedback. UserFeedback is also used when giving comments on Agents or Actions or when suggesting an Action to an Agent.

### 2.3.4 Value Part

A Value is an ethical value that an Agent can say they subscribe to or value more than other values. Each value is tied to an entity, which is a common representation of an object in the Actics system. It's used for searching and generating readable URLs to all the objects the entities represent. Every value is created by a userType and therefore has a relation to the UserFeedback. Each value can have several Definitions and each definition therefore has a reference to a UserFeedback domain object.

2.3.5 Action Part

An Action has, like a Value an Entity, making it searchable and linkable. Is Action also created by one of the userTypes, shown via the relation to UserFeedback. Each Action can also be commented individually and each ActionComment is created by a userType, represented by the relation to UserFeedback.

### 2.3.6 Proxy Network Part

Top part describes the structure involved in inviting to join proxy families. Here an invite is sent and stored in NetworkInvite with a reference to both the inviter and the invitee in the form of UserFeedback. When the userType accepts the invitation we get to the bottom part of the figure.

Bottom part shows the structure involved in to userTypes becoming networked. Here user A has a NetworkMember where he is the owner and user B is the member, which references a NetworkType which indicates the type of network user A has formed with user B and which weighting user A gives ratings from user B. Likewise user B has a NetworkMember in which he is owner and user A is member.

### 3 Implementation

### 3.1 Code

In this section we will describe the principles in the code and general structure.

3.1.1 Structure

The general structure of the code can be describes as follow, an ASP.Net page needs some data from the database and calls a method on the Manager class. The Manager class builds a query using our Data-Query Language using the Table representation classes calls the Data-Query System in Utilities. The Data-Query System then converts the query built in the Data-Query Language into standard SQL queries and executes the query on the SQL Server. The Data-Query System then sends the result back to the Manager, which creates the Object representations of the Data (the Item classes) and feeds them back to the ASP.Net page which then handles the rendering of the data. This split enables us to have a Data-Query System that can be used for several solutions that require access to a database. They just need to create a representation of the database table and an object representation which it translates into.

3.1.2 Data Query Language

The Data-Query Language is an object-oriented system used to access data in an SQL database via standard method calls in C#. The Data-Query System has been made to catch errors in the SQL calls at compile time, which would be caught at runtime using the standard way of creating SQL query strings.

### 3.1.2.1 Select

```
public static UserEmailConfirmItem
LoadEmailConfirmationByConfirmationKey(string key)
    {
      //instance of the DB table
      TableUserEmailConfirmations table = new
      TableUserEmailConfirmations( );
      //Query Type: SELECT
      DBQuery query = new
      DBQuery(DBQuery.DBQueryTypes.Select);
      //SELECT content part
      query.Select(table.ConfirmKey, table.UserID, table.Email,
table.Created, table.LastSend);
      //FROM part
      query.ReferenceTables(table);
      //WHERE part
      query.Where(table.ConfirmKey == key);
      //retrieve the data and convert to object representation
      return query.ConstructObject(typeof(UserEmailConfirmItem)) as
UserEmailConfirmItem;
    }
```

### 3.1.2.2 Insert

```
public static string CreateUserEmailConfirmation(Guid userID, string
email)
  {
      TableUserEmailConfirmations table =
      new TableUserEmailConfirmations( );
      DBQuery query = new
      DBQuery(DBQuery.DBQueryTypes.Insert);
      string key;
      key = ActicsGlobal.GenerateKey(20);
        //Assign values to the new intance
      query.AssignValues(
        table.ConfirmKey <= key,
        table.UserID <= userID,
        table.Email <= email,
        table.Created <= DateTime.Now,
        table.LastSend <= DateTime.Now);
      query.ReferenceTables(table);
      query.Execute( );
      return key;
    }
```

### 3.1.2.3 Update

```
public static void
UpdateUserEmailConfirmationByKey(UserEmailConfirmItem
emailConfirmation)
    {
      TableUserEmailConfirmations table = new
      TableUserEmailConfirmations( );
      DBQuery query =
      new DBQuery(DBQuery.DBQueryTypes.Update);
      query.ReferenceTables(table);
      query.AssignValues(table.LastSend <= DateTime.Now);
      query.Where(table.ConfirmKey ==
      emailConfirmation.ConfirmKey);
      query.Execute( );
    }
```

### 3.1.2.4 Delete

```
public static void DeleteUserEmailConfirmationByUserID(Guid userID)
    {
      TableUserEmailConfirmations table = new
      TableUserEmailConfirmations( );
      DBQuery query = new
      DBQuery(DBQuery.DBQueryTypes.Delete);
      query.ReferenceTables(table);
      query.Where(table.UserID == userID);
      query.Execute( );
    }
```

### 3.1.3 Relationship Between the Object, Data Object and the Database Table

This table is used to show the connection between the database tables and their object representations via the Database Query Language data objects. For instance to retrieve an Agent, which is a tuple in the Agents table, one must retrieve it via the Database Query Language using the TableAgents data object, which in creates an AgentItem object which is used in the system.

| Object | Data Object | DB Table |
|---|---|---|
| AgentItem | TableAgents | Agents |
| Action- | TabelActionEndorsements | Actiont-Endorsements |
| EndorsementsItem | | |
| ActionItem | TableActions | Actions |
| ActivityItem | TableActivities | Activitites |
| AgentActionItem | TableAgentActions | AgentActions |
| AgentCommentItem | TableAgentComments | AgentComments |
| AgentRatingItem | TableAgentRatings | AgentRatings |
| AgentStatsItem | TableAgentStats | AgentStats |
| AgentValueItem | TableAgentValues | AgentValues |
| AgentWishItem | TableAgentWishes | AgentWishes |
| CountryItem | TableCountries | Countries |
| EntityItem | TableEntities | Entities |
| MessageItem | TableMessages | Messages |
| NetWork- | TableNetworkMembers | NetworkMembers |
| MemberItem | | |
| NetworkTypeItem | TableNetworkTypes | NetworkTypes |
| UserFeedbackItem | TableUserFeedback | UserFeedback |
| UserItem | TabelUsers | Users |
| UserProfile | TableuserProfiles | UserProfiles |
| ValueDefinitionItem | TableValueDefinitions | ValueDefinitions |
| ValueItem | TableValues | Values |

### 3.1.4 Principles/Practices

The following principles or practices we have used are used to keep the code as easy for a new guy to understand as possible, without burdening the coder with too much extra work.

### 3.1.4.1 Capitalizing Identifiers

We try to use our own mix of Camel Case, Pascal Case and Hungarian Notation. We use Hungarian Notation³ for naming ASP.Net controls (eg. ddlCountry which is a Drop Down List of countries). Though Hungarian Notation is somewhat archaic we find it useful to distinguish between variables of standard .Net code (C# in our case) and ASP.Net Controls we have used. ³http://en.wikipedia.org/wiki/Hungarian_Notation

We use our own prefixes and suffixes to mark different classes that are in the Core and Utilities part of the system. Item is suffixed on the end of the object representations of the data in the database., eg. AgentItem. Table is prefixed to the table representations of the database tables in C# classes, eg. TableAgents. Manager is suffixed to the central control classes for accessing the database and other general methods. Eg.

AgentManager handles basic CRUD operations on Agents, but also other closely associated objects. Those associated objects could be AgentActions, AgentWishes, etc. For other naming we have followed Microsofts naming guidelines: http://msdn2.microsoft.com/en-us/librarv/x2dbyw72(VS.71).aspx, which is a mix of PascalCase and CamelCase⁴. ⁴http://en.wikipedia.org/wiki/Camelcase

### 3.1.4.2 Naming Principles

Generally we try to make the naming of methods and variables as telling as possible. This can create longer method names, but helps to understand what the method does. Eg. We have a method called LoadAllEmailConfirmationsByUserID which retrieves all the Email Confirmations in the database which have been created by a certain user identified by his userID.

### 3.1.4.3 Comments

For the time being our methods aren't extensively commented, but it is something that is being added when revisiting methods for further development or bug fixing and for new methods created. The style of commenting we use is the built in commenting style in Visual Studio that looks like the following example for a method:

/// <summary>
/// Description text
/// </summary>
/// <param name=“paramA“>paramA is...</param>
/// <returns>return type etc.</returns>

It is also encouraged that comments are added to the harder parts of the method body, which the standard commenting methods. Also adding class comments to classes, is encouraged but not very extensive at the moment.

In the future it would be advisable to use a (code) documentation generator like nDoc⁵ or SandCastle⁶ to compile these class and method comments. Though SandCastle is in development my Microsoft and therefore not complete and not easy to use yet and nDoc doesn't fully support .Net 2.0 yet. ⁵http://ndoc.sourceforge.net/⁶http://www.microsoft.com/downloads/details.aspx?FamilyID=E82EA71D-DA89-42EE-A715-696E3A4873B2&displaylang=en

### 3.1.5 URL Rewriting

The Actics system uses the way described in the following article: http://msdn2.microsoft.com/en-us/library/ms972974.aspx

We have created a HTTP Module that intercepts the incoming HTTP requests and returns the correct page. This is achieved getting the HTTP request and checking to see if it's one of the system or user generated URLs (entities that are saved in the database) and then

retrieving the correct method based on the root URL (ie./users/), which then handles the rest of the URL arguments, if any.

### 3.2 Components

To ease the development of Actics.com we have acquired some components to help with areas that would take too much time for us to develop from scratch.

### 3.2.1 Contact Inviter

This component is able to retrieve contacts from several sources. It can retrieve all the emails you have in your address book on all of the major free webmails (eg. Gmail, Hotmail) and import via comma separated files (.csv), which most mail programs can export to.

Basically it enables quick and painless retrieval of email addresses. You supply it with the login information for a webmail (which is not saved) or a CSV file and retrieve a collection of the data which you can use how you like.

Check out the following URL for more information: http://www.octazen.com/product_abimporter.php

3.2.2 jQuery

jQuery is a light and cross-browser compliant Javascript library that simplifies and enables a lot of smart functionality, which works in all the major browsers and is CSS 1-3 compliant. It also has methods to ease Ajax routine calls.

jQuery supplies a factory method object called $ which can be used to call javascript functions. These functions are chainable.

So one could write the following $(div.agent).addClass(agentLtis).css(color, red); which would select all html <DIV>s with the CSS class agent, add another CSS class agentList and add the a CSS attribute called color and set color to red. Check out the following URL for more information:

http://jquery.com/
Documentation for jQuery:
http://docs.jquery.com/Main_Page

What is claimed is:

1. A method for evaluating the behavior of a user in relation to one or more ethical values, comprising:
obtaining inputs rating the performance of the user in relation to the one or more ethical values;
weighting the inputs according to a predetermined criterion; and
determining an overall rating based on the weighted inputs.

2. A system for evaluating the behavior of a user in relation to one or more ethical values, comprising a computing device comprising computer-executable instructions on a computer-readable medium, the computer-executable instructions causing the computing device to: (i) weight inputs rating the performance of the user in relation to the one or more ethical values; and (ii) calculate the overall rating based on the weighted inputs.
